(19) United States
(12) Patent Application Publication
(10) Pub. No.: US 2009/0229727 A1
(43) Pub. Date: Sep. 17, 2009

(54) TIRE WITH PROTECTIVE MEMBER MOUNTED IN SIDEWALL

(76) Inventors: Robert Allen Losey, Kent, OH (US); John Steven Attinello, Uniontown, OH (US); Jack Edward Brown, Akron, OH (US); Charles Kenneth Schmalix, Canal Fulton, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 12/403,425

(22) Filed: Mar. 13, 2009

Related U.S. Application Data
(60) Provisional application No. 61/036,443, filed on Mar. 13, 2008.

(51) Int. Cl. B60C 13/02

(52) U.S. Cl. 152/523

(57) ABSTRACT

The invention relates to a pneumatic tire with a toroidal shaped tire carcass having sidewalls and a tread. The tire carcass terminates at opposite bead regions for mounting on a tire rim. The tire has at least one of the sidewalls having a projection of rubber having a groove, and a removable member provided in the groove for forming a decorative or colored rim flange protector.

### TECHNICAL FIELD

The present invention generally relates to the construction of pneumatic tires and more particularly the sidewall area and rim flange protection of a tire.

### BACKGROUND OF THE INVENTION

For many years, tire manufacturers have considered the use of colored sidewalls. One technique known in the art embeds the desired colored compound into the characteristic black sidewall stock of the tire during the extruding or the fabrication of the sidewall and prior to the first stages of tire fabrication or building. The colored compound is normally covered with a thin layer or laminate of black sidewall stock commonly referred to as a cover strip. The tire is subsequently completed in conventional fashion as in the manufacture of a standard black wall tire through the shaping and vulcanization steps. Subsequent to vulcanization, grinding or butting equipment is employed to remove portions of the cover strip and expose the extent of colored compound necessary to achieve the predetermined desired decorative effect. Other ways of adding color to sidewalls have also been proposed. Commercial acceptance of these methods have been limited because of the additional cost associated with the additional processing steps and the increased number of imperfect tires caused by the additional processing.

### BRIEF DESCRIPTION OF THE DRAWINGS

Reference will be made in detail to preferred embodiments of the invention, examples of which are illustrated in the accompanying drawings. The drawings are intended to be illustrative, not limiting. Certain elements in selected ones of the drawings may be illustrated not-to-scale, for illustrative clarity.

FIG. 1 is a cross-sectional view of a portion of a tire with a removable member and rim flange protector;

FIG. 2 is a close up view of the removable member and rim flange protector of FIG. 1;

FIG. 3 is a close up view of the removable member and rim flange protector of FIG. 2 shown with an optional flex groove;

FIG. 4 illustrates a second embodiment of a removable member having a cap and split base cross-section;

FIG. 5 is a third embodiment of a removable member;

FIG. 6 is a fourth embodiment of a removable member.

### DEFINITIONS

“Apex” means an elastomeric filler located radially above the bead core and between the plies and the turnup ply.

“Axial” and “Axially” means the lines or directions that are parallel to the axis of rotation of the tire.

“Axially Inward” means in an axial direction toward the equatorial plane.

“Axially Outward” means in an axial direction away from the equatorial plane.

“Bead” or “Bead Core” generally means that part of the tire comprising an annular tensile member of radially inner beads that are associated with holding the tire to the rim; the beads being wrapped by ply cords and shaped, with or without other reinforcement elements such as flippers, chippers, apexes or fillers, toe guards and chafers.

“Belt Structure” or “Reinforcement Belts” means at least two annular layers or plies of parallel cords, woven or unwoven, underlying the tread, unanchored to the bead, and having both left and right cord angles in the range from 17E to 27E relative to the equatorial plane of the tire.

“Breakers” or “tire breakers” means the same as belt or belt structure or reinforcement belts.

“Bead” or “Bead Core” generally means that part of the tire comprising an annular tensile member of radially inner beads that are associated with holding the tire to the rim.

“Carcass” means the tire structure apart from the belt structure, tread, undertread over the plies, but including the beads.

“Circumferential” most often means circular lines or directions extending along the perimeter of the surface of the annular tread perpendicular to the axial direction; it can also refer to the direction of the sets of adjacent circular curves whose radii define the axial curvature of the tread, as viewed in cross section.

“Cord” means one of the reinforcement strands of which the plies and other cord-reinforced components of the tire are comprised.

“Green carcass” means the uncured tire carcass prior to the installation of the belt structure and tread.

“Insert” means the cross-sectionally crescent- or wedge-shaped reinforcement typically used to reinforce the sidewalls of runflat-type tires.

“Lateral” means a direction parallel to the axial direction.

“Ply” means a cord-reinforced layer of rubber coated radially deployed or otherwise parallel cords.

“Radial” and “radially” mean directions radially toward or away from the axis of rotation of the tire.

“Radial ply structure” means the one or more carcass plies of which at least one ply has reinforcing cords oriented at an angle of between 65° and 90° with respect to the equatorial plane of the tire.

“Radial ply tire” means a belted or circumferentially-restricted pneumatic tire in which at least one ply has cords which extend from bead to bead are laid at cord angles between 65° and 90° with respect to the equatorial plane of the tire.

“Shoulder” means the upper portion of sidewall just below the tread edge.

“Sidewall” means that portion of a tire between the tread and the bead.

“Tangential” and “tangentially” refer to segments of circular curves that intersect at a point through which can be drawn a single line that is mutually tangential to both circular segments.

“Tread” means the ground contacting portion of a tire.

“Tire crown” means the tread, tread shoulders and adjacent portions of the sidewalls.

### DETAILED DESCRIPTION OF THE PREFERRED EMBODIMENT

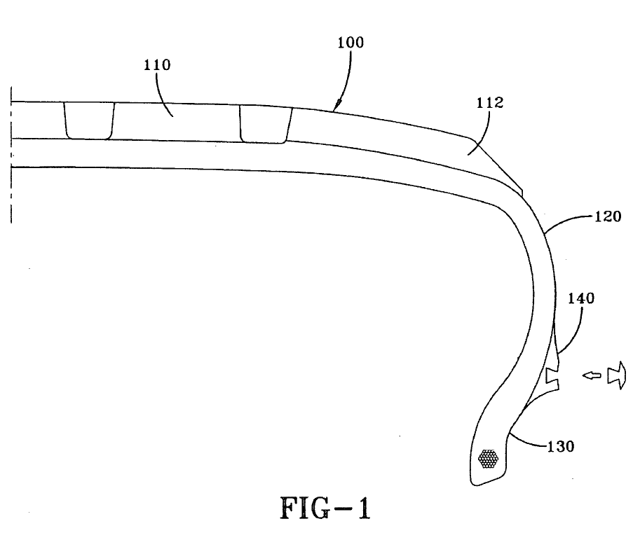

Referring to FIG. 1, there is shown the partial cross section of a tire suitable for use as a passenger tire, truck tire for example, but not limited to same. The tire includes a tread portion 110 comprising a ground engaging tread having two outer shoulders 112 and a circumferential belt structure (not shown) located between the shoulders and radially inward of the tread. The tire 100 may further include two bead areas (not shown) and other such common elements as chafers, chippers, and flippers. Elastomeric sidewalls 120 extend radially outward from the bead areas respectively, to the tread shoulders 112. The tire 100 may further comprise a carcass structure comprising at least one cord reinforced elastomeric ply (not shown) extending outward from each bead area through the sidewalls 112. The sidewalls may further comprise a rubber projection or rim flange protector 140, which may be provided on one or both of the sidewalls 120. The rim flange protector may typically be mounted near the general bead areas 130 of the tire, although not required. The rim flange protector 140 preferably comprises a continuous, circumferential elastomeric projection extending axially outward from a sidewall 120 so that the projection extends radially outward of the rim flange (not shown) of a rim.

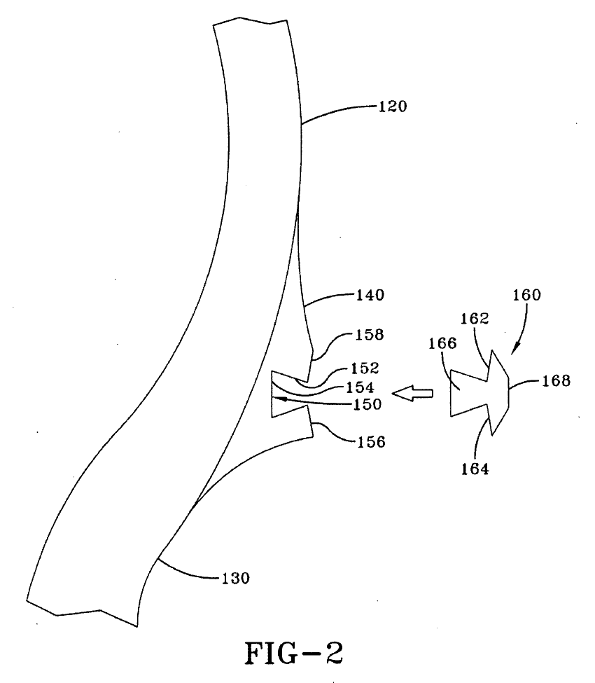

A close-up view of the rim flange protector 140 is shown in FIG. 2. The rim protector 140 further comprises a groove 150, which is preferably circumferentially continuous (i.e., circular), although not required. The groove 150 may have any desired configuration, and may for example, comprise a sector or arc-shaped groove. The cross-sectional shape of the groove 150 is preferably “dove-tailed” shape, such that the inner portion 152 of the groove is narrower than the outer portion 154 of the groove. However, the cross-sectional shape of the groove may vary and have straight sidewalls for example. The groove 150 further comprises side portions 156,158 which may be shaped complementary to mate with side edges 162,164 of a second member 160. The second member 160 is preferably ring shaped or arc-shaped. The second member 160 may be comprised of a precured elastomeric or rubber member which is assembled to the tire post-cure. The second member 160 may also comprise plastic, metal, alloys, thermoplastic or thermoplastic elastomers. Preferably, the second member 160 is made of polyurethane. More preferably, the second member is made of a polyurethane ring having a hardness greater than the sidewall hardness. For example, in order to further enhance the protective effect of the rim flange protector, the second member preferably has a hardness of 85 or more.

As shown in FIG. 2, the second member 160 has an outer cap 166 which is seen by the consumer, and an inner portion 166 which is received in or “snapped into” groove 150. The inner portion 166 may have an interference fit with groove 150. The inner portion 166 is complementary shaped to be received in groove 150. The shape of the outer cap 168 may vary as desired. The outer cap may be larger or smaller as desired, and has a decorative aspect in addition to providing a rim protector feature and may be colored as desired. The outer cap may be decorative, and may be colored as desired for a decorative effect. The outer cap is preferably non-black in color. The decorative cap may additionally comprise one or more lights such as led lights for enhanced visibility. The decorative cap may also comprise highly reflective material or materials which glow in the dark. Further, the outer cap may have identifying indicia such as a trademark or logo. The second member may be a ring shaped member, arc shaped member, or comprise additional shapes as desired.

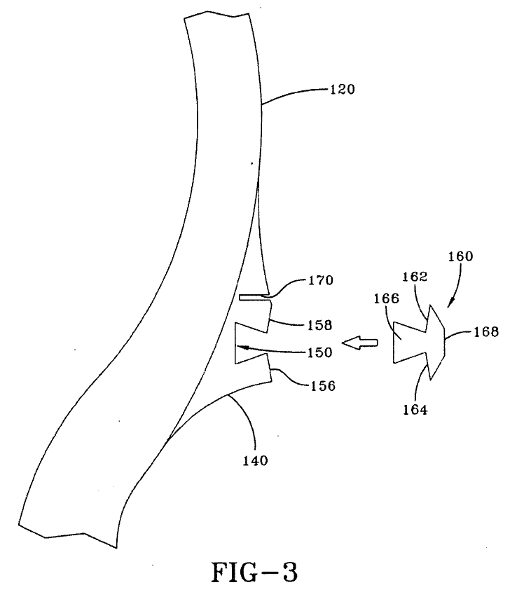

FIG. 3 illustrates a second embodiment of the invention which is similar to the embodiment of FIG. 2, with the addition of a flexible groove 170. The flexible groove is preferably located adjacent the groove 150 and provides resiliency of the rim flange protector 140 should a shock occur. The flexible groove 170 helps to deter the dislodging of the member from the groove.

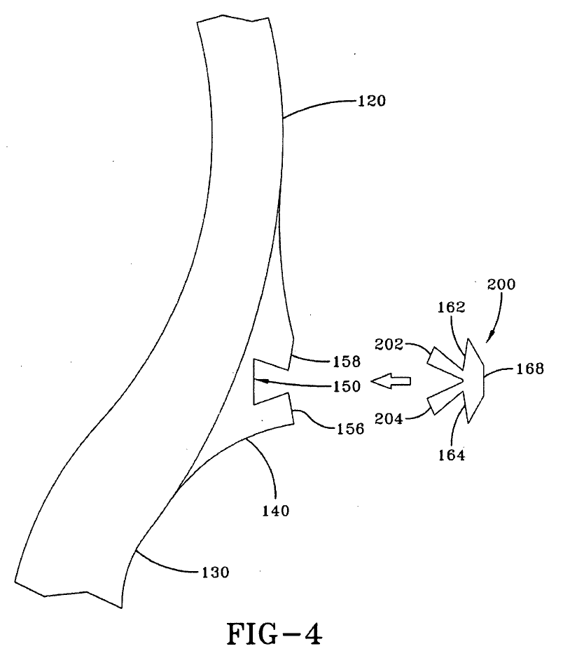

FIG. 4 illustrated a third embodiment of the invention which is similar to the embodiment of FIG. 2, except that the second member 200 has a different shape. The inner portion of the second member has been split into two or more portions, 202, 204. The two or more portions 202, 204 are received in the groove 150, and provide a spring like effect in order to help facilitate the retention of the portions 202,204 within the groove.

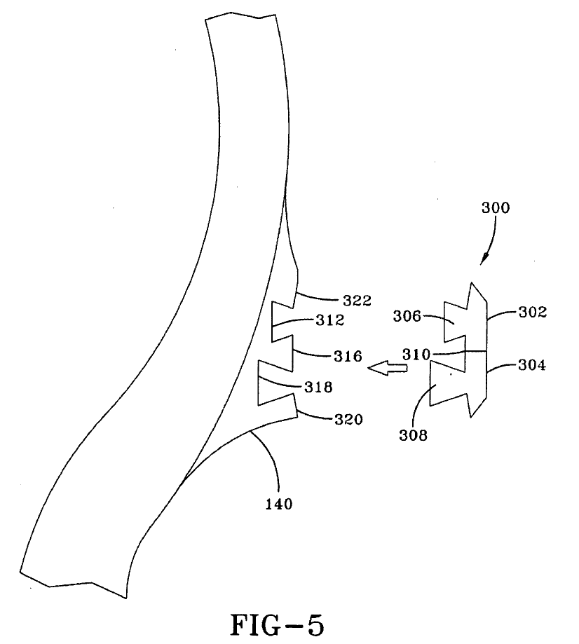

FIG. 5 illustrates a fifth embodiment of the invention. The rim flange protector 140 comprises two or more grooves, 314, 318 for receiving two or more projections 306,308 of a removable member 300, therein. The removable member has an elongated outer cap 302, 304 which may comprise two or more colors. The projections 306, 308 are preferably dove-tail shaped for snapping into grooves 314,318.

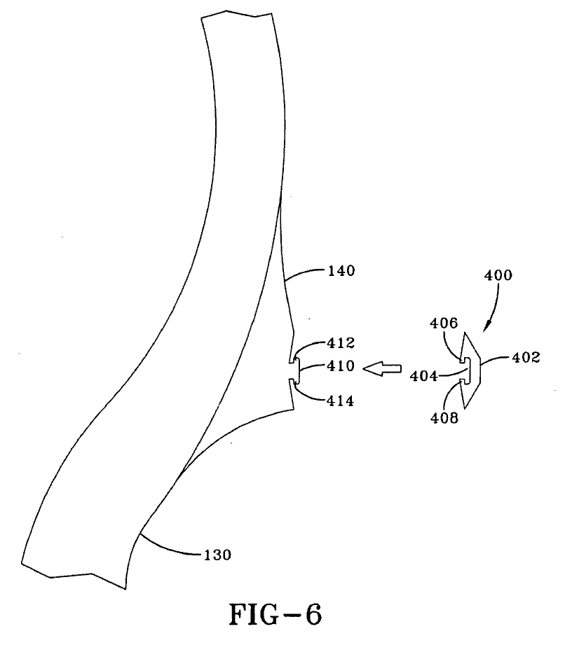

FIG. 6 illustrates a sixth embodiment of the invention. In this embodiment, the rim flange protector 140 has an outward projection 410, which is preferably T shaped. A removable member 400 has an outer cap 402 and an inner groove 404 opposite the cap. The inner groove has two opposed retention members 406,408 which are held in place onto the tire by the outer lip 412,414. The member is preferably mounted to the tire post cure. The cap 400 may be is threaded onto the outer projection 412 in a circumferential manner, or snapped into place using axial force.

For all of the above described embodiments, the second member 160 may be mounted into the sidewall prior to closing the mold during the vulcanization of the tire 100. Preferably, the second member 160 is inserted into the molded in groove 150 after the tire has been vulcanized. In that event, the base portion 166 can be adhered within the groove 150, respectively, by either the tight fit between the base portion and the groove, or with an adhesive placed within the groove to insure that sufficient adhesive forces can be developed that the second member stays in place. In all of the embodiments described above, the second member 160 can be installed and/or removed from the vulcanized tire at a later time so as to insert another ring for reasons such as styling (using a different color ring or logo) or if the ring is damaged.

The above described embodiments are not limited to the location near the rim flange. Member 140 may be located anywhere on the sidewall.

The invention has been illustrated and described in a manner that should be considered as exemplary rather than restrictive in character. It is understood that only preferred embodiments have been shown and described, and that all changes and modifications that come within the scope of the invention are desired to be protected. Undoubtedly, many other “variations” on the techniques set forth hereinabove will occur to one having ordinary skill in the art to which the present invention most nearly pertains, and such variations are intended to be within the scope of the invention, as disclosed herein.

What is claimed:

1. A pneumatic tire comprising a toroidally shaped carcass having sidewalls and a tread, the carcass terminating at opposite bead regions for mounting on a tire rim,
Wherein at least one of the sidewalls has a projection of rubber extending from the sidewall, wherein the projection has a groove;
a removable member having an outer cap and an inner base, wherein the inner base is secured within the groove.

2. The pneumatic tire of claim 1 wherein the groove is a circumferentially extending continuous groove.

3. The pneumatic tire of claim 1 wherein the removable member is ring shaped.

4. The pneumatic tire of claim 1 wherein the removable member is constructed of a material from the group consisting essentially of rubber, plastic, metal, alloys, thermoplastic and thermoplastic elastomers.

5. The pneumatic tire of claim 1 wherein the removable member is made of polyurethane.
